(19) United States
(12) Patent Application Publication
(10) Pub. No.: US 2016/0381619 A1
(43) Pub. Date: Dec. 29, 2016

(54) Routing Based on Quality Metrics

(71) Applicant: TELEFONAKTIEBOLAGET LM ERICSSON (PUBL), Stockholm (SE)

(72) Inventors: Johan Axnäs, Solna (SE); Kumar Balachandran, Pleasanton, CA (US); Dennis Hui, Sunnyvale, CA (US); Tim Irnich, Neuss (DE); Jonas Kronander, Knivsta (SE); Miurel Isabel Tercero Vargas, Sollentuna (SE)

(21) Appl. No.: 15/112,628

(22) PCT Filed: Jan. 20, 2014
(86) PCT No.: PCT/SE2014/050062

§ 371 Date: Jul. 19, 2016

(51) Int. Cl. H04W 40/12; H04W 48/02; H04W 24/02

(52) U.S. Cl. CPC H04W 40/12; H04W 24/02; H04W 48/02; H04W 40/16

(57) ABSTRACT

Methods, apparatuses, and computer program products provide for routing information between nodes of a radio network. A quality metric is received at a network node that indicates a quality of at least one channel of a plurality of channels in the network. A virtual network is generated that includes one or more routes between a source node and a destination node. A modified virtual network is generated based at least in part on the quality metric and the virtual network, and is then used to determine an optimized route between the source node and destination node. The determination includes a joint selection of one or more of a plurality of network nodes and the plurality of the channels.

### TECHNICAL FIELD

This disclosure relates generally to radio access networks and, more particularly, to routing communications through radio access network nodes.

### BACKGROUND

It is expected that a substantially denser deployment of base stations and/or wireless access nodes will be required in the future. The dense deployment of wireless radio access nodes will require a backhaul network that can provide high-data-rate transport for each individual access node in the network. In order to maximize capacity, optical-fiber-based backhaul solutions may be used, and are well suited for new construction. However, in existing buildings and infrastructure, the cost of installation of new fibers to every access node in a very dense network could be prohibitive.

An alternative to the fiber backhaul solution is the wireless self-backhaul solution, where the same access spectrum is used to provide both service and transport. With self-backhauling, an access node may serve not only its own assigned user equipment (UEs) in its vicinity, but also its neighboring access nodes as a relaying node in order to route data towards and/or from other nodes, such as an information aggregation node in the network. The traffic flow routes may be determined, for instance, using a routing algorithm. Finding optimal routes can be a very complex task.

### SUMMARY

According to some embodiments, methods, apparatuses, and computer program products provide for routing information between nodes of a radio network are provided.

In some embodiments, a method for routing information between a source node and a destination node in network having a plurality of network nodes and a plurality of channels is provided. The method includes receiving a quality metric at a first node of the network, where the quality metric indicates a quality of at least one channel of the plurality of channels. The method also includes generating a virtual network that includes one or more routes between the source node and destination node. The method also includes generating a modified virtual network based at least in part on the quality metric and the virtual network. The modified network is then used to determine an optimized route between the source node and destination node. This determination includes a joint selection of one or more of the plurality of network nodes and a plurality of the channels. The quality metric may be received, for instance, from a spectrum controller.

In some embodiments, a network node having a processor and a memory is provided. The memory contains instructions executable by the processor, whereby the network node is operable to receive a quality metric that indicates a quality of at least one channel of a plurality of channels in a network having a plurality of network nodes. The network node is also operable to generate a virtual network that includes one or more routes between a source node and a destination node, as well as generate a modified virtual network based at least in part on the quality metric and the virtual network. The network node then uses the modified network to determine an optimized route between the source node and destination node. This determination includes a joint selection of one or more of the plurality of network nodes and a plurality of the channels. The quality metric may be received, for instance, from a spectrum controller.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 is an illustration of a network in accordance with exemplary embodiments.

FIG. 2 is an exemplary directed graph representation of a network.

FIGS. 3A and 3B are graph representations of a network in accordance with exemplary embodiments.

FIGS. 4A and 4B are graph representations of a network in accordance with exemplary embodiments.

FIG. 5 is a block diagram of network components in accordance with exemplary embodiments.

FIG. 6 is a flow chart illustrating an information routing process in accordance with exemplary embodiments.

FIGS. 7A and 7B are graph representations of a network in accordance with exemplary embodiments.

FIG. 8 is a graph representation of a network in accordance with exemplary embodiments.

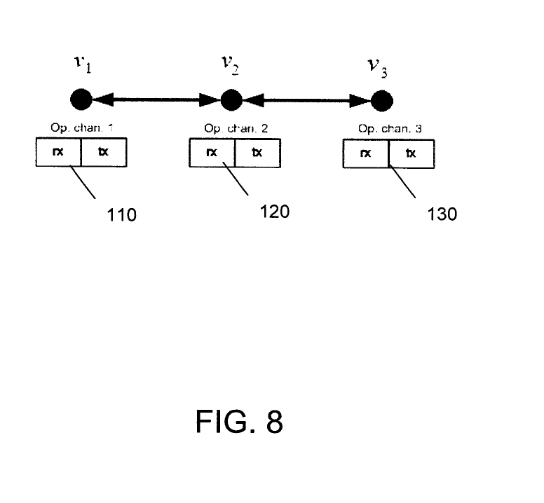

FIG. 9 is a block diagram of a network node in accordance with exemplary embodiments.

### DETAILED DESCRIPTION

Particular embodiments are directed to methods, devices, and computer program products for routing information in a network. Information may be routed along selected paths in the network, which may include multiple network nodes operating over various channels, such as network nodes within a wireless self-backhauling network.

In a wireless self-backhaul implementation, an access node may serve not only the user equipment (UEs) in its vicinity, but also neighboring access nodes as a relay node in order to route data, for instance, between source and destination nodes. In some instances, a group of self-backhauling access nodes can form a multi-hop mesh network. Although the present disclosure may refer to self-backhauling networks to provide potential context, one of ordinary skill in the art will recognize that the routing techniques disclosed herein are not so limited.

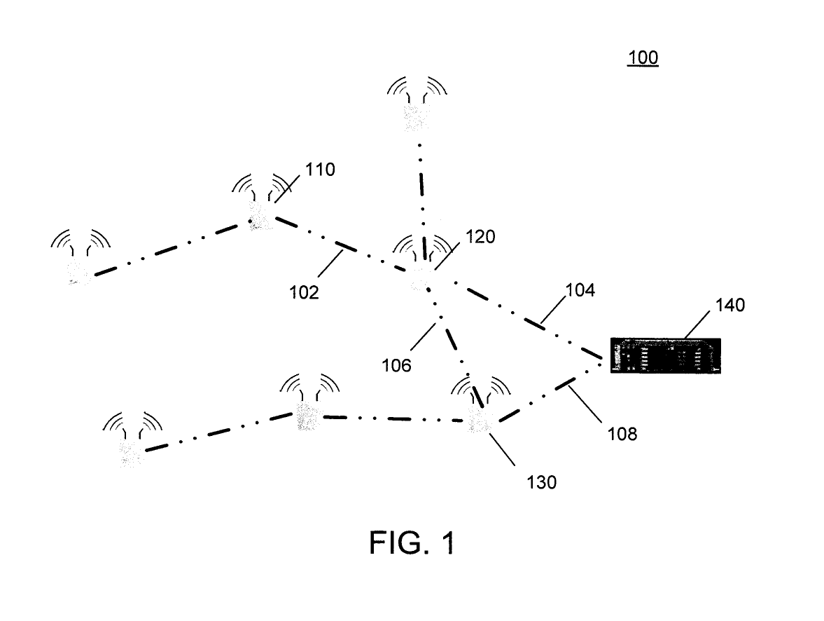

An exemplary mesh topology for self-backhauling access nodes is provided in FIG. 1, which illustrates a group of self-backhauling radio access nodes, including nodes 110, 120, and 130, that form a part of multi-hop mesh network 100. In this example, the access nodes cooperatively route each other's traffic to and from an aggregation node 140 through wireless radio communication links, such as links 102, 104, 106, and 108. The routes that the traffic should follow may be selected using a routing algorithm. In general, a network may contain more than one aggregation node and any number of access nodes. The system may contain one or more routing units, which may be centralized or distributed across one or more network nodes, for performing route selection processes.

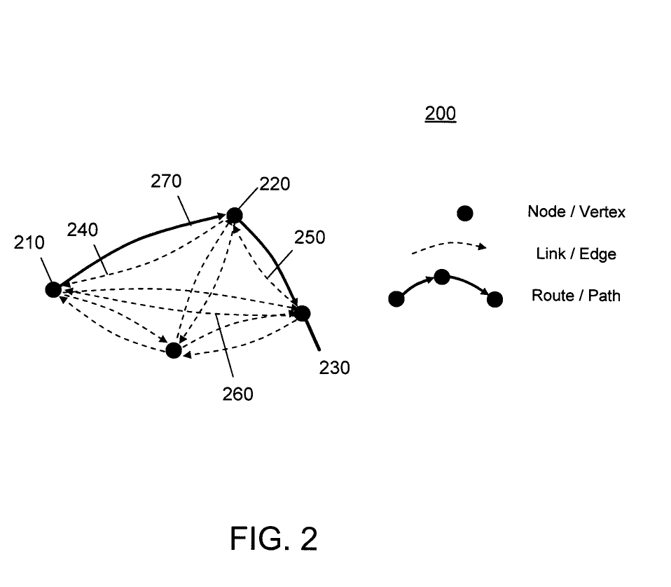

A radio network can be represented mathematically by a graph. For instance, a network may be represented by a directed graph, where network nodes are represented by a graph vertex, and potential wireless links (or “hops”) in the network are represented by a graph edge. In an exemplary directed graph, such as the graph 200 illustrated in FIG. 2, a graph, G, is given as

G≡(V,E),

where V denotes the set of (graph) vertices (e.g., 210, 220, and 230), and E denotes the set of (graph) edges (e.g., 240, 250, and 260), each connecting two vertices in V. Each network node may be represented by a vertex vεV, and each (potential) wireless link between two distinct nodes is represented by an edge eεE. An edge e can be represented by an ordered pair e=(v,v′), where v and v′ must be in V. As such, a graph may be defined not only through an illustration, for instance as shown in FIG. 2, but also textually and/or numerically through the use of equations, tables, and/or other numerical representations. For instance, a graph may be given by a table or other data structure that identifies vertices/nodes and edges/links, and may also include any number of their properties.

A route or path 270 between nodes is also shown in the graph representation of FIG. 2. These connected components are referred to herein as a “basic graph representation” of a wireless network, such as network 100. This basic representation essentially captures the topological structure characterized by the inter-node connectivity within the network. The terms relating to the real network (e.g., node and link) and the corresponding terms relating to the graph representation (e.g., vertex and edge) may be used interchangeably herein. For instance, graph 200 could represent a network, such as network 100 shown in FIG. 1. In this example, one or more of nodes 210, 220, and 230 could correspond to nodes 110, 120, and 140. Thus, links 240 and 250 would correspond to links 102 and 104, respectively, where the route from wireless node 110 to aggregate node 140 (or vice-versa) would correspond to the path 270 from graph node 210 to graph node 230.

A route 270 from a source node (e.g., aggregation point of the backhaul network) to a destination node (e.g., a UE or a distant access node) can be represented by a path P in the network, which may be understood as an alternating sequence of vertices and edges:

v₁,(v₁,v₂),v₂,(v₂,v₃),v₃, . . . ,vᵢ,(vᵢ,vᵢ₊₁),vᵢ₊₁, . . . ,v_{K},

where vᵢεV for all i=1, 2, . . . , K and (vᵢ,vᵢ₊₁)εE for all i=1, 2, . . . , K−1, and where K−1 is the number of edges on the path P, v₁ is the start vertex, typically representing a source node of a route in the wireless network, and v_{K} is the end vertex, typically representing a destination node. For any given path P, one may define V(P) as the set of all vertices {vᵢ}ᵢ₌₁^{K} on the path P, and define E(P) as the set of all edges {(vᵢ,vᵢ₊₁)}ᵢ₌₁^{K-1} on the path P. One of ordinary skill will recognize that since the vertices of a valid edge in E must be in V, a path may be simply represented by a sequence of edges in E.

According to some embodiments, the radio network 100 can be configured to operate on a number of different operating channels (e.g., frequency bands, ranges, carriers, etc.). However, not every channel will necessarily be authorized or available for use in all places at all times. For example, certain channels may be prohibited because they are assigned to another system with higher priority in the area, often referred to as “primary systems.” Also, even if a channel is not explicitly prohibited, there may (e.g., in unlicensed frequency bands) be strong interference from other systems, leading to poor channel quality and preventing efficient operation on the channel. Thus, in some instances, a channel may only be partially available, for example, due to constraints that result from sharing the channel with other systems. Further, which channels are allowed and/or have acceptable quality may vary from access node to access node in a system (e.g., depending on location of the node). In some embodiments, a spectrum controller (centralized or distributed to each node) may be used, which has an operating channel assessment (OCA) functionality to determine, inter alia, for each node (and/or each potential link between any two nodes), what channels are allowed for use and the quality of the respective channels. This determination may be made, for example, by collecting and processing information from various entities both internal and external to the network.

How the channels are selected for any two hops in a wireless network can have a direct impact on a number of link performance metrics, including their mutual interference, and thus on the performance metrics of any routes that pass through these links. Therefore, route selection and channel selection in wireless networks are closely related issues. While they can be separately considered, for instance, by assigning orthogonal resources to all mutually interfering nodes in the network in order to decouple all interfering links, substantial degradation in the achievable performance may result from excessive partitioning of radio channels.

As described herein, a better approach is to jointly optimize route selection and channel selection. In such a system, a network's radio resource management unit may need to not only determine which sequence of nodes the data traffic to a certain destination should use, but it may also take into account which operating channel(s) are allowed for use and what quality they have in each link/hop along a route, in order to decide which node should be using which channel.

Existing technologies for routing and resource allocation do not adequately handle situations where different frequency bands, carriers, or operating channels have different qualities. For example, they do not handle situations where the router receives and needs to take into account information from a spectrum controller. Moreover, due to hardware limitations, a network node may only be able to transmit (or receive) on a single frequency band at any given time. In some cases, a network node may be hardware-limited and therefore required to transmit and receive on a common frequency band. Thus, special care must be taken when assigning resources across different frequency bands if joint route selection and resource allocation across multiple frequency bands is to be performed.

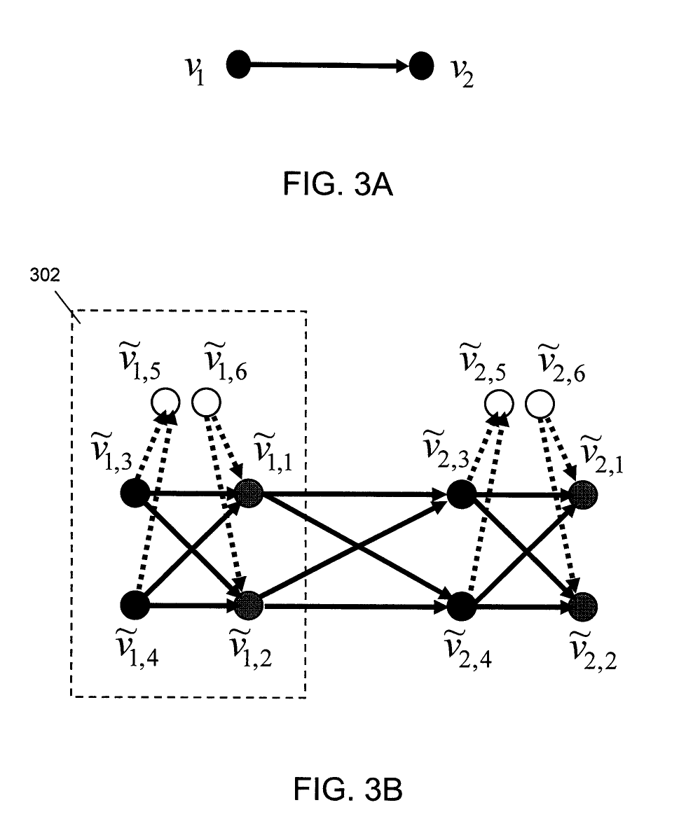

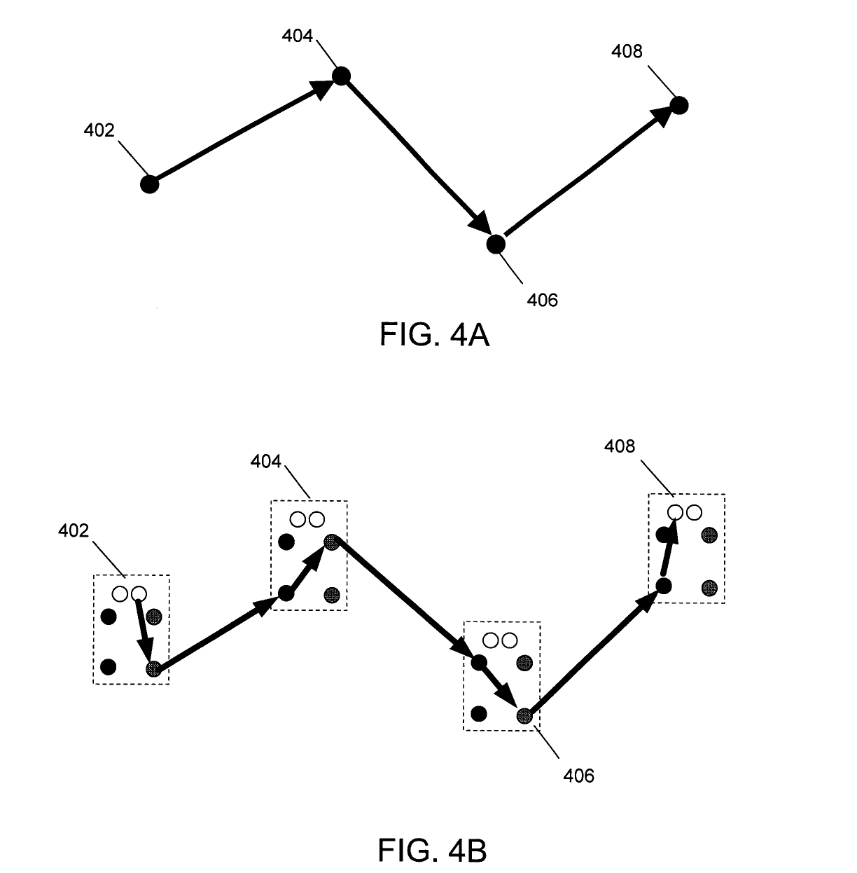

One method of achieving joint optimization is to use what may be referred to as an “augmented graph representation” or “virtual network representation” of the network. In the augmented-graph method, each network node may be represented not by one graph vertex as in the basic graph representation of FIG. 2, but rather by multiple graph vertices, which are used to represent different ways of allocating channels at the network node. A path selection in such an augmented graph jointly determines a sequence of network nodes (i.e., the route) and the corresponding resources allocated to the links in the route. Exemplary augmented graph representations of the basic network graphs of FIGS. 3A and 4A are shown in FIGS. 3B and 4B, respectively.

According to some embodiments, a channel quality metric can be used in joint routing and resource allocation. For example, an operating channel assessment device, such as a spectrum controller, can construct a quality metric for each frequency band or operating channel in each node (or for each link between a pair of nodes). This quality metric, which may be a numeric value, can include an indication that an operating channel is available, partially available, or completely unavailable. The quality metric may then be communicated to a routing device (or logical unit having routing functionality). In some embodiments, the routing device may first construct a virtual network or augmented graph representation, which disregards, or only partially applies, the quality metric. The links in the virtual network may then be updated or otherwise modified to reflect the quality metric for use in joint routing and resource allocation.

The links of the virtual network may also be modified using other metrics, for instance, by considering channel measurements obtained by the routing device itself. The links can also be updated to reflect transmission prohibitions, restrictions on transmission and reception in a common frequency band, and overlapping channels between neighbors. Ultimately, the routing device performs routing functions using the virtual network, thereby jointly deriving a routing and a resource allocation in the real network, where the obtained routing and resource allocation solution are based at least in part on the factors and/or constraints from the spectrum controller. This allows joint routing and channel selection in a multi-hop network, and thereby increases system performance, e.g., in terms of throughput.

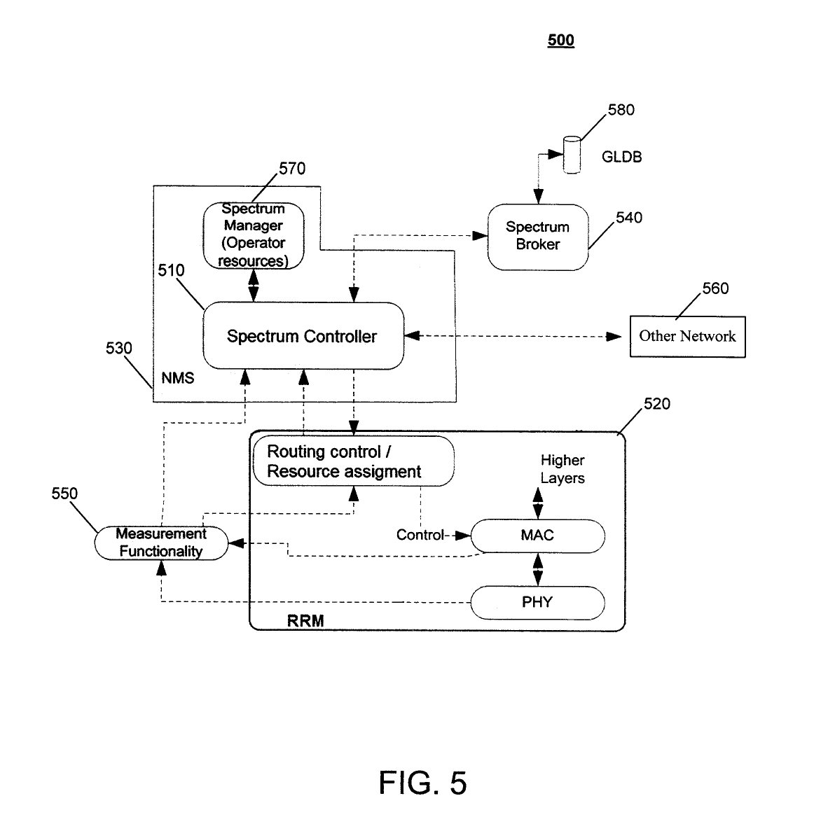

Referring now to FIG. 5, according to some embodiments, information regarding channel information, including quality metrics, may be communicated between a spectrum controller 510 and routing device 520. These components may interact to enable effective joint routing in a network, such as network 100.

As is shown in FIG. 5, the spectrum controller 510 may be part of a larger network management system (NMS) 530. This system 530 may also include a spectrum manager 570 of the operator. The spectrum controller 510 may be in communication with the spectrum manager 570, as well as spectrum allocation entities such as spectrum broker 540 and geo-location database 580. In some embodiments, these allocation entities are external entities; however, they may also be internal to the network. The spectrum controller 510 may also be connected to another network 560, including an inter-network coordination manager. The spectrum controller may also be connected to one or more measurement functionalities 550.

Each of these components can be used to provide information to the spectrum controller to help it determine channel characteristics and availability in the network 100, including quality metrics. The quality metrics can then be sent to the routing device 520, which is in communication with to the spectrum controller 510. The routing device 520 may also have control over the MAC and PHY layers of the network. In some embodiments, the measurement functionality 550 may be tied to the routing functionality, for instance, by obtaining channel information from the PHY layer of the network.

One of ordinary skill in the art will recognize that the spectrum controller 510 and routing device 520 of FIG. 5 may be physically embodied in numerous ways. For instance, spectrum controller 510 and routing device 520 may be separate logical units of a single device, such as a network node (e.g., 110,140) or a dedicated spectrum controlling or routing device. Alternatively, spectrum controller 510 and routing device 520 may be separate devices, or form logical components of separate devices. Further, the functionality of these components may be distributed across one or more devices. For example, the routing functionality may be distributed across one or more nodes (e.g., 110,140) of network 100. In the case of distributed routing functionality, a particular node (e.g., 110,140) may only determine a portion of a routing solution.

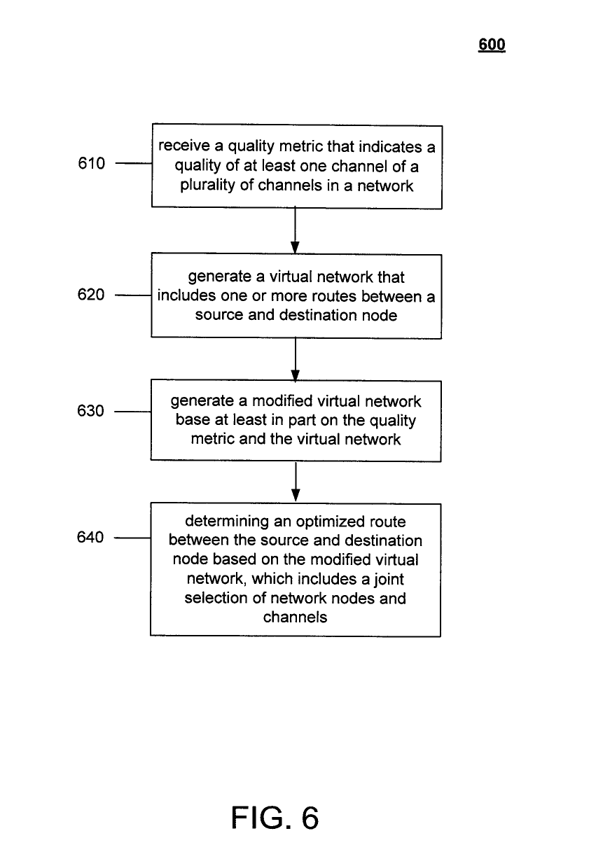

Referring now to FIG. 6, a process 600 is shown for routing information between a source node and a destination node in a communication system having a plurality of network nodes and channels. The process may be applied, for instance, to route information in network 100 of FIG. 1 from a source node, such as aggregation point 140, to a destination node, such as network node 110. Routing process 600 is not limited, however, to routing communications between an aggregation point and an access node and may be applied across any nodes of a network, including access nodes of a mesh topology for self-backhauling. In some embodiments, source and destination nodes may be simultaneously connected by multiple different routes through the network 100.

In step 610, a quality metric is received at a first node of a plurality of radio network nodes, such as a node of network 100. The quality metric may be received, for instance, either directly or indirectly and at any number of nodes, and may be relayed to other nodes of the network. The receiving node may be, for example, a wireless access point, such as node 110 or intermediate node 120, an aggregation node, such as node 140, or another node configured to contain routing functionality. In some embodiments, the routing functionality may be distributed over more than one node of network 100.

In some embodiments, the quality metric is received from a channel assessment source, such as a spectrum controller 510, and indicates a quality of at least one of the plurality of channels in the communication system. As discussed above, a spectrum controller 510 may be centralized or distributed and may be used to determine, inter alia, for each node (and/or each potential link between any two nodes), what channels are allowed for use and the quality of the respective channels. For instance, the quality metric may indicate that a channel is available, partially available, or unavailable.

In step 620, a virtual network is generated, which represents one or more routes between the source node and the destination node. In some embodiments, the virtual network may be understood as an augmented-graph representation of the network 100, having network nodes that are represented not only by singular graph vertices, as in the basic graph representation shown in FIG. 2, but rather by multiple graph vertices, which are used to represent different possible ways of allocating radio channels at the network node, for instance, as shown in FIGS. 3B and 4B. A path in such an augmented graph jointly identifies a sequence of network nodes (i.e. the route) and the corresponding channels allocated to the links in the route. The vertices of the virtual or augmented graph may be referred to as virtual nodes, and in order to avoid ambiguity the physical network nodes may be referred to as real nodes.

In an augmented-graph representations, a network is represented by a directed graph

\tilde{G}≡(\tilde{V},\tilde{E}),

with \tilde{V} and \tilde{E} being the sets of vertices and edges, respectively (for clarity, quantities related to an augmented graph will generally be labeled with a tilde sign). Each real node, such as nodes 110 and 140, will typically correspond to more than one virtual graph vertex, i.e. one vertex vₖεV in the basic representation may correspond to several vertices

\tilde{v}_{k,i}ε\tilde{V}, i=1,2, . . . Iₖ

in the augmented representation, where Iₖ denotes the number of vertices in the augmented graph belonging to the vertex vₖεV in the basic graph. For example, in the augmented-graph represented in FIG. 3B, real node v₁ is represented by a set of graph vertices 302, including v_{1,1}, v_{1,2}, v_{1,3}, v_{1,4}, v_{1,5}, and v_{1,6}.

Similarly, each (potential) wireless link will may correspond to more than one edge in the augmented graph. For example, given a basic graph G≡(V,E), an augmented graph \tilde{G}≡(\tilde{V},\tilde{E}) of G may be defined as a graph satisfying the following two conditions. First, there exists a mapping, ƒ_{y}:\tilde{V}→V, such that

ƒ_{V}(\tilde{v})=v

for any \tilde{v}ε\tilde{V} that corresponds to the real node vεV. Second, there exists a mapping, ƒ_{E}:\tilde{E}_{D}→E, such that

ƒ_{E}(\tilde{e})=e

for any \tilde{e}ε\tilde{E}_{D} that corresponds to the real edge eεE, where \tilde{E}_{D} is the subset of \tilde{E} that contains all edges (\tilde{v},\tilde{v}′)ε\tilde{E} such that

ƒ_{V}(\tilde{v})≠ƒ_{V}(\tilde{v}′)

that is, the corresponding real nodes of any edges in \tilde{E}_{D} are different, and where an edge

\tilde{e}=(\tilde{v},\tilde{v}′)ε\tilde{E}

is said to correspond to an edge e=(v,v′)εE if and only if ƒ_{V}(\tilde{v})=v and ƒ_{V}(\tilde{v}′)=v′. For example, with respect to the augmented graph of FIG. 4B, multiple edges exist representing the link between nodes 402 and 404 (as well as 404 to 406 and 406 to 408)

As is clear from the foregoing, any basic graph G≡(V,E) can also be an augmented graph of itself. There are many possible variants of augmented graph representations satisfying these requirements (e.g., FIG. 4), and the exact choice may be guided by the specifics of the problem being considered, e.g. network type and what routing metric and routing algorithms are being used. In some embodiments, graph edges connecting virtual nodes belonging to different real nodes may be understood as channel links, while edges connecting virtual nodes within the same node may be understood as intra-real-node virtual links.

In step 630, a modified virtual network is generated using the quality metric received in step 610. The generation of a modified network may include assigning channel link metrics to the links of the virtual network. The channel links may correspond, for instance, to the quality metrics received from the spectrum controller 510.

In some embodiments, the assigning of a channel link metric may take into account additional link information, for example, that existed in conjunction with the original virtual network. That is, the assigned channel link metric may be based on both the received quality metric and additional link metrics. The assigned channel link metric may be, for instance, a sum, a weighted sum, or a ratio of the quality metric and the additional link metrics. The link metrics could be obtained directly by the routing device 520, or received from spectrum controller 510 or another source.

For example, if the spectrum controller indicates that a certain channel has good quality for a certain link, the virtual channel link corresponding to that channel can be assigned a large cost. For example, if w_{bit}_{_}ᵣₐₜₑ (l) denote the original bit rate metric of link l in the basic graph, let \tilde{l}(l,c) denote the virtual link corresponding to link l operating on channel c, and let q(l,c)ε[0,1] denote a quality metric received from the spectrum allocator for link l and channel c, with a larger value of q(l,c) representing a better channel quality for link l. The metric of the virtual link \tilde{l}(l,c) may be defined as

\tilde{w}_{bit}_{_}ᵣₐₜₑ(\tilde{l}(l,c))≡ƒ(q(l,c),w_{bit}_{_}ᵣₐₜₑ(l)),

where ƒ(•,•) denotes a certain combining function used to modify the original link metric w_{bit}_{_}ᵣₐₜₑ(l) according to the quality metric of the channel c when it is used for link l. Simple examples of the combining function ƒ(•,•) include ƒ(x,y)≡x·y, ƒ(x,y)≡αx+y for some constant α, or ƒ(x,y)≡log₂(1+x(e^{y}−1)) (which use the quality metric to scale the effective SNR of the link).

In some embodiments, a quality metric received from spectrum controller 510 may indicate whether a channel is allowed or not. For instance, it might assume only two values: allowed channel and non-allowed channel. In the augmented graph representation, the assigned channel links corresponding to allowed channel could then be given a link cost of zero (or another cost based on measurements by the router), whereas the channel links corresponding to non-allowed channels would be given infinite link cost. Therefore, the routing function would not select a route using a non-allowed channel.

In some embodiments where the quality metric indicates channel availability, it may take on one of a number of predefined values. For instance, the values {0, 0.5, 1} may corresponding to {unavailable, partially available, available}. Thus, an assigned composite link metric could be derived using a mathematical operator on one or more additional metrics. For instance, a router metric could be divided by the quality metric, thus ensuring that minimization of the cost function will weight available channels higher (assuming that the partially available channel has been secured for use by the network).

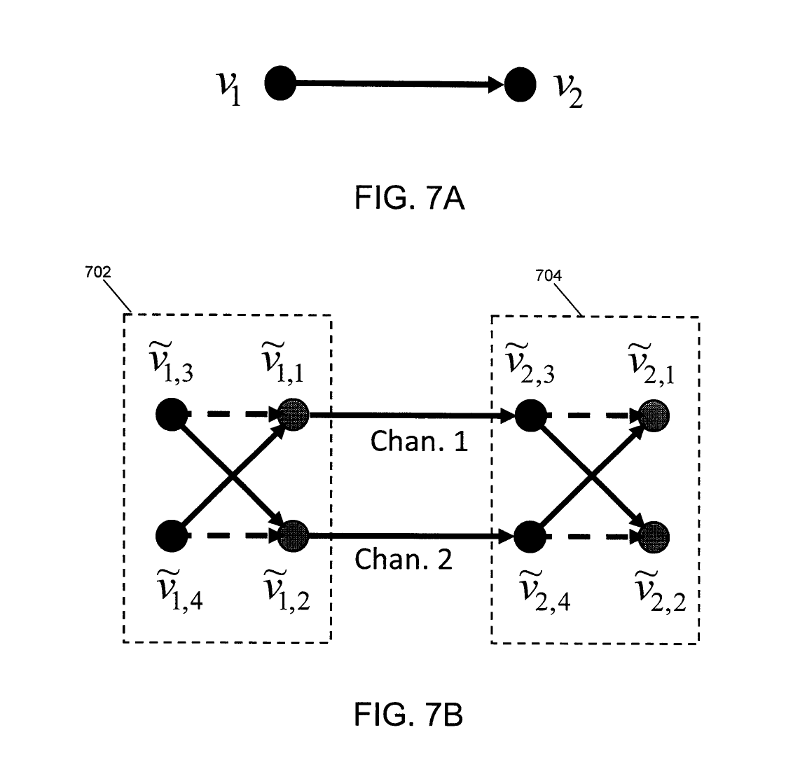

In some embodiments, a restriction may be imposed such that a given network node must not transmit and receive on different channels. This restriction may be necessary, for instance, due to hardware constraints of the node. Using FIGS. 7A and 7B as an example, the “diagonal” (solid in the illustration) intra-real-node links at nodes 702 and 704 may be assigned a very large (or infinite cost), sufficient to impose the restriction. In other words, if \tilde{v}_{k,j} is a virtual receiving node and \tilde{v}_{k,j′} is a virtual transmitting node, then the edge (\tilde{v}_{k,j},\tilde{v}_{k,j′}) would be given an infinite edge cost if j≠j′+Jₖ. In this case, virtual nodes 702 and 704 correspond to nodes v₁ and v₂ of the basic graph representation of FIG. 7A.

Having generated the modified virtual network, in step 640, an optimized communication route between the source and destination node is determined by analyzing the modified virtual network and selecting the route based on the analysis. Due to the use of the modified virtual network, this determination includes the joint selection of one or more network nodes and channels. In some embodiments, information transmission between the source and destination node may be authorized, or otherwise initiated, using the selected route. Thus, the information is communicated to the jointly selected network node(s) on the jointly selected channel(s). These may be, for example, radio nodes and radio channels in an ultra-dense network (UDN) and/or wirelessly self-backhauling network. In some embodiments, for instance in the example of distributed routing functionality, the determination of the route may include determining a part of a route. That is, the determined route of step 640 may be the entire route between the source and destination node or a part of the route between the source and destination node.

As discussed above, in order to transport information wirelessly between a source node and a destination node, the appropriate route(s) must be selected from among the possible routes with one or more hops to carry the information to the destination node. The routing functionality 520 that selects the appropriate route can either be centralized at a single node, (e.g., the aggregation node making the routing decision) or distributed with multiple nodes making consistent routing decisions locally. The following exemplary routing algorithms are provided with respect to the centralized case; however, the concepts are also applicable in the distributed case.

In some embodiments, route selection is performed by first defining a routing metric, and then searching for the route(s) that optimize(s) that metric. Mathematically, the routing metric

μ:E*→ [symbol] ,

where μ is a real-valued function on E*, provides a quantitative measure of the desirability of a route or path where [symbol] denotes the set of real values. A best route

P={vᵢ}ᵢ₌₁^{K},

between a source node v₁ and a destination node v_{K} may be determined as the route that yields the smallest (or largest) routing metric μ(P). A routing metric μ(P) of a path P is often expressed as a simple function of the link metric w(l) assigned to each individual link lεE(P) along the route P, with

μ(l)≡w(l).

Such a function determines how the routing metric μ(P) of a path P relates to those of its sub-paths.

For example, a hop-count metric of a path P may simply be the total number of links in the path, such that

μ_{hop-count}(P)=|E(P)|=Σ_{lεE(P)}w_{hop-count}(l),

where w_{hop-count} (l)=1, and the latency metric of a path P is simply the sum of the latencies of the individual links. That is,

μ_{latency}(P)=Σ_{lεE(P)}w_{latency}(l)).

In this case, the routing metric is an additive metric in the sense that μ(P₁⊕P₂)=μ(P₁)+μ(P₂) for all sub-paths P₁ and P₁ of P such that P₁⊕P₂=P.

As another example, a throughput metric may be used in route selection. The throughput metric of a path P may be defined as the minimum (bottleneck) of the link bit rates along the path. That is,

μ_{bitrate}(P)=min_{lεE(P)}w_{bitrate}(l),

where w_{bitrate}(l) denotes the data rate supportable by link l. In this case, the routing metric is a minimum metric in the sense that μ(P₁⊕P₂)=min{μ(P₁),μ(P₂)} for all sub-paths P₁ and P₂ of P such that P₁⊕P₂=P.

As another example, the probability of correctly delivering a packet may be used as a routing metric. The probably of correctly delivering a packer over a path P is the product of the probabilities of correctly delivering the packet over individual link

$${μ}_{prob \_ correct} ( P ) = {\prod }_{l ∈ E ( P )} {w}_{prob \_ correct} ( l ) ,$$

where w_{prob}_{_}_{correct}(l) denotes the probability of correct detection of link l. In this case, the routing metric is a multiplicative metric in the sense that μ(P₁⊕P₂)=μ(P₁)·μ(P₂) for all sub-paths P₁ and P₂ of P such that P₁⊕P₂=P.

Depending on the metric type (e.g., additive, minimum, multiplicative), the path weight should either be minimized or maximized. For example, the latency should likely be minimized, whereas the bit rate should likely be maximized. In some embodiments, it may be convenient (or necessary) to consistently use metrics of a limited number of types. This can be achieved by converting metrics of another type to the desired type. For example, instead of bit rate (which should be maximized) one may use the inverse of the bit rate (which should be minimized).

Although the propagation characteristics of wireless links are typically reciprocal, the effective baseband channels in uplink and downlink typically are not, for example, due to the different interference environments and the potential transmit-power level disparity at the respective source nodes in uplink and downlink. Therefore, different routes may be established separately for uplink and downlink between a source and destination node, such as an aggregation node and an access node (in an infrastructure mesh) or a UE (in a device-mesh). Thus, the foregoing is applicable to the determination of different routes for uplink and downlink. However, in practice, having a single route for both uplink and downlink may be preferred to reduce system complexity in some instances.

In some embodiments, a more detailed allocation may be jointly determined. For instance, each operating channel may be subdivided into multiple frequency (and or time) slots that can be individually allocated. Routing and resource allocation in such a process can also be performed using the augmented graph representation. In the case where nodes can use multiple operating channels concurrently, such routing and resource allocation is obtained by replacing the analysis of a “channel” with analysis of a “slot” in the preceding descriptions. In some embodiments, a node may not be able to use multiple channels simultaneously. Thus, the inter-real node links that connect virtual nodes of different channels and slots may be set to an infinite edge cost, as described with respect to the restriction of FIG. 7B.

In some embodiments, if there are multiple nodes (e.g., UEs) to derive routes to, one approach is to derive the routes one by one independently. However, if there is a constraint that nodes can only use one channel at a time, it will be necessary to let all routes (e.g., to different UEs) go via the same channel in each node. This can be achieved by iterating a routing process over all the channels available in the system, one by one, and for each channel deriving a candidate routing solution to all nodes using only that channel. From these candidate solutions, one that optimizes the performance of the system may be selected.

In some embodiments, a particular channel may not be available in a region of a network, for instant, because of constraints in place due to network sharing. The reason for this may be, for example, that there is a different system operating on the channel in a given region. In this case, the links in the concerned channel and concerned region may be set to have an infinite edge cost in the augmented graph, thereby preventing the routing function from selecting links using the prohibited channel in the region of concern.

In some embodiments, network 100 may include certain nodes (such as radio access nodes) that may be capable of tuning over one or more frequency bands that overlap with a neighboring node. For instance, node 120 of network 100 may be able to tune to a first frequency band that overlaps with the transmit and/or receive frequencies of neighboring node 110, and is able to tune to a second frequency band that overlaps with the transmit and/or receive frequencies of another neighboring node, such as node 130. An example is shown in FIG. 7 having three adjacent nodes (e.g., corresponding to nodes 110, 120, and 130) capable of tuning over three operating channels, but with the second node 120 (Op. Chan. 2) capable of operating over resources that are common to the operating channels of node 110 (Op. Chan. 1) and node 130 (Op. Chan. 3). This type of a resource assignment could be used, for example, to bridge orthogonal channel assignments in two parts of the network, or even between two sub-networks that have established routes. According to some embodiments, the constraint to change channel across a portion of the network (such as node 120) can be indicated by the spectrum manager as a modification of the metric associated with the resource allocation for the transmission from nodes. The virtual nodes would be associated with the appropriate sub-bands of each channel.

According to some embodiments, the selection criteria may take into account both the interference generated by neighboring links that constitute the route (intra-route interference) and the interference generated by links that constitute the other routes (inter-route interference). Thus, joint routing and resource selection using an augment-graph representation may be well suited to determining routes in wireless mesh networks, since it allows node self-interference to be efficiently considered.

For instance, in an augmented representation such as FIG. 3B, each real node vₖ may be represented by multiple sets of virtual nodes. One set includes virtual transmitting nodes

\tilde{v}_{k,i}ε\tilde{V}, i=1,2, . . . ,Jₖ

and represents Jₖ different ways of allocating resources when transmitting from the node (e.g., Jₖ different sets of one or more channels). In embodiments where routing is constrained to using only one channel in each hop, each Jₖ could denote one specific channel. A second set includes virtual receiving nodes

\tilde{v}_{k,i}ε\tilde{V}, i=Jₖ+1,Jₖ+2, . . . ,Jₖ+Jₖ′

and represents Jₖ′ different ways of receiving from other nodes (e.g., Jₖ′ sets of one or more channels). A third set includes virtual destination node

\tilde{v}_{k,J}_{ₖ}_{+J}_{ₖ}_{′+1},

which is a virtual node to which data transmissions with the real node vₖ as a final destination should go. In some embodiments, the virtual destination node is needed in real nodes that are potential destination nodes (e.g., aggregation node 140 or UEs). A fourth set includes virtual source node

\tilde{v}_{k,J}_{ₖ}_{+J}_{ₖ}_{′+2},

from which data transmission from the real node vₖ should originate. Thus, in this example, the total number of virtual nodes corresponding to the real node vₖ is

Iₖ=Jₖ+Jₖ′+2.

Within each real node, there may be connections (directed edges) from every virtual receiving node to every virtual transmitting node, and there may also be inter-real-node connections between each virtual transmitting node in one real node and each virtual receiving node in another real node. However, many of the connections may be assigned an infinite edge cost, in other words, effectively missing or omitted. In the example of FIG. 3B, all edges are included.

Therefore, in some embodiments, the step of jointly finding a route from source vₖ to destination vₖ, and allocating channels in each link consists in finding a path from \tilde{v}_{k,J}_{ₖ}_{+J}_{ₖ}_{′+1} to \tilde{v}_{k′,J}_{_{k′}}_{+J}_{_{k′}}_{′+1} in the augmented graph. FIG. 4B provides an illustration of a route from an aggregation node 402 to a second node 408, such as a UE, via other access nodes (404,406).

According to some embodiments, routing solutions may be understood as either “one-channel routes” or “multi-channel routes.” With respect to one-channel routes, the route may be limited to using exactly one channel out of N_{channels} available channels from each link along its path. Each real node may then be represented by N_{channels} virtual receiving nodes and N_{channels} virtual transmitting nodes. For instance, FIG. 7B provides an example of N_{channels}=2.

With respect to multichannel routes, nodes can receive or transmit on multiple channels in each link. For instance, in a direct application of the augmented-graph method, each real node vₖ could be represented by Jₖ=2^{N}^{_{channels}}−1 virtual transmitting nodes and Jₖ′=2^{N}^{_{channels}}−1 virtual receiving nodes, with each virtual node representing one possible way if transmitting or receiving, respectively, using any combination of 1, 2, . . . , or N_{channels} channels simultaneously. In some instance, for example due to size or processing constraints, it may be desirable to determine multi-channel routes using a generalized or modified one-channel graph/route.

One way of establishing multi-channel routes is to construct them from a set of one-channel routes that are added one by one in an iterative fashion. For instance, a routing device 220 could first establish an initial one-channel route between each source and destination node (according to the method of establishing a one-channel route described above), and then gradually “widen” those one-channel routes into multi-channel routes by adding, one by one, more one-channel routes along the same sequences of real nodes.

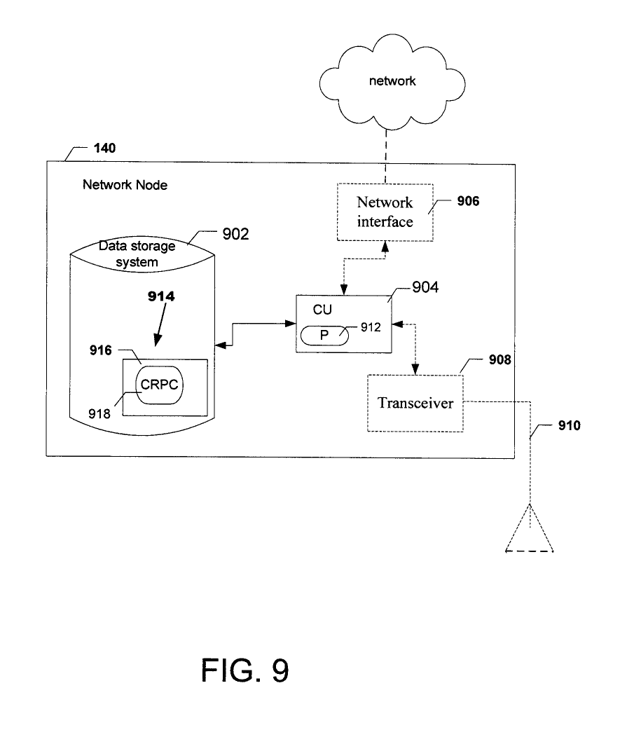

FIG. 9 illustrates a block diagram of an example network node 140. The network node 140 may be, for example, a radio access node or aggregation node. In some embodiments, routing functionality may be enabled in node 140. Thus, in some embodiments, node 140 may function as a routing device 520.

In the embodiment shown in FIG. 9, network node 140 includes: control unit (CU) 904 (e.g., a data processing system), which may include one or more processors (P) 912 (e.g., microprocessors) and/or one or more circuits, such as an application specific integrated circuit (ASIC), Field-programmable gate arrays (FPGAs), etc.; a data storage system 902, which may include one or more computer-readable data storage mediums, such as non-transitory memory unit (e.g., hard drive, flash memory, optical disk, etc.) and/or volatile storage apparatuses (e.g., dynamic random access memory (DRAM)). Depending on the capabilities and communication techniques of the network node 140, it may also include a network interface 906 for connecting the node 140 to additional network devices, such as spectrum controller 510, and may also include a transceiver 908 coupled to an antenna 910 for wireless communication with, for example, nodes 120 and 130 of network 100.

In embodiments where control unit 904 includes a processor 912 (e.g., a microprocessor), a computer program product 914 may be provided, which computer program product includes: computer readable program code 918 (e.g., instructions), which implements a computer program, stored on a computer readable medium 916 of data storage system 902, such as, but not limited, to magnetic media (e.g., a hard disk), optical media (e.g., a DVD), memory devices (e.g., random access memory), etc. In some embodiments, computer readable program code 918 is configured such that, when executed by control unit 904, code 918 causes the control unit 904 to perform steps described herein (e.g., steps shown in FIG. 6).

In some embodiments, node 140 is configured to perform steps described above without the need for code 918. For example, control unit 904 may consist merely of specialized hardware, such as one or more application-specific integrated circuits (ASICs). Hence, the features of the present invention described above may be implemented in hardware and/or software. For example, in some embodiments, the functional components of network node described above may be implemented by control unit 904 executing program code 918, by control unit 904 operating independent of any computer program code 918, or by any suitable combination of hardware and/or software.

While various embodiments have been described above, it should be understood that they have been presented by way of example only, and not limitation. Thus, the breadth and scope of the present disclosure should not limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-31. (canceled)

32. A method for routing information between a source node and a destination node in a network having a plurality of network nodes and a plurality of channels, comprising:
receiving a quality metric at a first node of said plurality of network nodes, wherein said quality metric indicates a quality of at least one channel of said plurality of channels in said network;
generating a virtual network that includes one or more routes between said source node and said destination node;
generating a modified virtual network based at least in part on said quality metric and said virtual network; and
determining an optimized route between said source node and said destination node based on said modified virtual network,
wherein said determining comprises a joint selection of one or more of said plurality of network nodes and a selection of one or more of said plurality of channels.

33. The method of claim 32, wherein said quality metric is received from a spectrum controller.

34. The method of claim 32, wherein generating the modified virtual network based at least in part on said quality metric includes assigning a channel link metric to at least one link of said one or more routes between said source node and said destination node.

35. The method of claim 34, further comprising:
obtaining, at said first node, one or more additional link metrics,
wherein said channel link metric is based on both said received quality metric and said additional link metrics.

36. The method of claim 35, wherein said channel link metric is one of a sum, weighted sum and ratio of said quality metric and said additional link metrics.

37. The method of claim 34, wherein assigning the channel link metric to at least one link of said one or more routes between said source node and said destination node comprises assigning said channel link metric to prevent a node of said network from transmitting and receiving information on different channels.

38. The method of claim 34, wherein assigning the channel link metric to at least one link of said one or more routes between said source node and said destination node comprises assigning said channel link metric to prevent a node of said network from transmitting or receiving information on a prohibited channel.

39. The method of claim 32, wherein said quality metric indicates that at least one channel of said plurality of channels is one of available, partially available and unavailable.

40. The method of claim 32, wherein said quality metric indicates that a channel of said plurality of channels is either available or unavailable, and the method further comprises:
if said channel is available, assigning said channel a channel link metric of 0; and
if said channel is unavailable, assigning said channel a channel link metric of 1 or more.

41. The method of claim 32, wherein said plurality of channels is subdivided into multiple frequency slots or time slots, and said determining comprises a joint selection of one or more of said plurality of network nodes and one or more slots.

42. The method of claim 32, wherein said determining comprises a joint selection of a network node and one or more of said plurality of channels,
wherein said selection of one or more of said plurality of channels is based at least in part on operating characteristics of one or more neighboring nodes of said selected network node.

43. The method of claim 42, wherein a receive channel for said selected network node is selected based on operating characteristics of a first neighboring node, and a transmission channel for said selected network node is selected based on operating characteristics of a second neighboring node.

44. The method of claim 32, wherein determining the optimized route between said source node and said destination node comprises:
deriving a first candidate route using a first of said plurality of channels;
deriving a second candidate route using a second of said plurality of channels;
comparing said first and second candidate routes; and
selecting said first or second candidate route based on said comparison.

45. The method of claim 32, wherein determining the optimized route between said source node and said destination node comprises:
deriving a first candidate route to said destination node; and
deriving a second candidate route to an additional node,
wherein said joint selection of one or more of said plurality of network nodes and a selection of one or more of said plurality of channels is based at least in part on both of said first candidate route and said second candidate route.

46. The method of claim 45, wherein said first candidate route and said second candidate route are derived using a first channel of said plurality of channels.

47. The method of claim 46, wherein determining the optimized route between said source node and said destination node comprises:
deriving a third candidate route to said destination node; and
deriving a fourth candidate route to an additional node,
wherein said third candidate route and said fourth candidate route are derived using a second channel of said plurality of channels and said joint selection of one or more of said plurality of network nodes and a selection of one or more of said plurality of channels is based at least in part on said first candidate route, said second candidate route, said third candidate route, and said fourth candidate route.

48. The method of claim 45, wherein said network is a network having a plurality of user equipments and said destination node is a first of said plurality of user equipments and said additional node is a second of said plurality of user equipments.

49. A network node, comprising:
interface circuitry configured as a network interface to send and receive communications; and
processing circuitry operatively associated with the interface circuitry and configured to:
receive a quality metric, wherein said quality metric indicates a quality of at least one channel of a plurality of channels in a network having a plurality of network nodes;
generate a virtual network that includes one or more routes between a source node and a destination node;
generate a modified virtual network based at least in part on said quality metric and said virtual network; and
determine an optimized route between said source node and said destination node based on said modified virtual network,
wherein said determining comprises a joint selection of one or more of said plurality of network nodes and a selection of one or more of said plurality of channels.

50. The network node of claim 49, wherein said quality metric is received from a spectrum controller.

51. The network node of claim 49, wherein said processing circuitry is configured to generate the modified virtual network based at least in part on said quality metric by:
assigning a channel link metric to at least one link of said one or more routes between said source node and said destination node.

52. The network node of claim 51, wherein said processing circuitry is configured to:
obtain one or more additional link metrics,
wherein said channel link metric is based on both said received quality metric and said additional link metrics.

53. The network node of claim 52, wherein said channel link metric is one of a sum, weighted sum and ratio of said quality metric and said additional link metrics.

54. The network node of claim 51, wherein said processing circuitry is configured to assign the channel link metric to at least one link of said one or more routes between said source node and said destination node by assigning the channel link metric to prevent a node of said network from transmitting and receiving information on different channels.

55. The network node of claim 51, wherein said processing circuitry is configured to assign the channel link metric to at least one link of said one or more routes between said source node and said destination node by assigning the channel link metric to prevent a node of said network from transmitting or receiving information on a prohibited channel.

56. The network node of claim 49, wherein said quality metric indicates that at least one channel of said plurality of channels is one of available, partially available and unavailable.

57. The network node of claim 49, wherein said quality metric indicates that a channel of said plurality of channels is either available or unavailable, and wherein said processing circuitry is configured to:
if said channel is available, assign said channel a channel link metric of 0; and
if said channel is unavailable, assign said channel a channel link metric of 1 or more.

58. The network node of claim 49, wherein said plurality of channels is subdivided into multiple frequency slots or time slots, and said processing circuitry is configured to determine a joint selection of one or more of said plurality of network nodes and one or more slots.

59. The network node of claim 49, wherein said processing circuitry is configured to determine a joint selection of a network node and one or more of said plurality of channels,
wherein said selection of one or more of said plurality of channels is based at least in part on operating characteristics of one or more neighboring nodes of said selected network node.

60. The network node of claim 59, wherein a receive channel for said selected network node is selected based on operating characteristics of a first neighboring node, and a transmission channel for said selected network node is selected based on operating characteristics of a second neighboring node.

61. The network node of claim 49, wherein said processing circuitry is configured to determine the optimized route between said source node and said destination node by:
deriving a first candidate route using a first of said plurality of channels;
deriving a second candidate route using a second of said plurality of channels;
comparing said first and second candidate routes; and
selecting said first or second candidate route based on said comparison.

62. The network node of claim 49, wherein said network node is said source node.
